(19) United States
(12) Patent Application Publication
(10) Pub. No.: US 2015/0177916 A1
(43) Pub. Date: Jun. 25, 2015

(54) DEVICES AND METHODS FOR PROVIDING FEEDBACK OF AN APPLICATION

(71) Applicant: Tencent Technology (Shenzhen) Company Limited, Shenzhen (CN)

(72) Inventors: Jinli CHENG, Shenzhen (CN); Hui XIONG, Shenzhen (CN); Tingli XU, Shenzhen (CN)

(73) Assignee: Tencent Technology (Shenzhen) Company Limited, Shenzhen (CN)

(21) Appl. No.: 14/610,230

(22) Filed: Jan. 30, 2015

Related U.S. Application Data
(63) Continuation of application No. PCT/CN2014/084605, filed on Aug. 18, 2014.

(30) Foreign Application Priority Data
Dec. 23, 2013 (CN) 201310721568.8

(51) Int. Cl. G06F 3/0481; G06F 3/0485

(52) U.S. Cl. CPC G06F 3/0481; G06F 3/04855; G06F 3/04817

(57) ABSTRACT

The invention relates to a method and a terminal device implementing the method. The terminal device provides a browsing interface displaying a page associating with the subject application. The page includes a main content area displaying main content of the page; and a feedback entry icon in the main content area, floating over the main content of the page. Further, the terminal device obtains a trigger instruction operated on the feedback entry icon; switches directly to a feedback window interface which corresponds to the feedback entry icon according to the trigger instruction; obtains feedback information with respect to the application or the main content inputted in the feedback window interface; submits the feedback information to a server in communication with the terminal device; and close the feedback window interface to return to the page.

### PRIORITY STATEMENT

This application is a continuation of International Application No. PCT/CN2014/084605, filed on Aug. 18, 2014, in the State Intellectual Property Office of the People's Republic of China, which claims the priority benefit of Chinese Patent Application No. 201310721568.8 filed on Dec. 23, 2013, the disclosures of which are incorporated herein in their entirety by reference.

### FIELD

The present disclosure generally relates to web page processing fields. Specifically, the present disclosure relates to devices and methods for providing feedback on a web page.

### BACKGROUND

With the development of network technology, network has become an indispensable part of people's life. Users install on a terminal (e.g., a mobile phone and/or a laptop computer) a browser or other application software and use the browser or application software to realize the corresponding functions, such as browsing the web through the browser to access to information. In order to collect users' experiences with the browser or software application, a feedback suggestion port is provided in the browser or the application software, so that the feedback suggestion of a user may be received through the feedback suggestion port.

Taking a browser as shown in FIG. 1A as an example, usually the user needs to seek the feedback suggestion port in the help menu on a page of the browser. After the user triggers (e.g., clicks) the feedback suggestion port, the browser will go to another page, as shown in FIG. 1B. After entering the page in FIG. 1B, the browser may require the user to further find an entry of a next step in order to provide feedback, which causes the operation complicated. Moreover, the above arrangement makes it difficult for the user to return to an original page after the user provides the feedback, which causes the operating inefficient, thereby wasting network resources.

### SUMMARY

According to an aspect of the present disclosure, a terminal device may comprising a processor-readable storage medium comprising a set of instructions for providing feedback of a subject application; and a processor in communication with the storage medium. The processor may be configured to execute the set of instructions to provide a browsing interface in a terminal device displaying a page associating with the subject application, wherein the page includes: a main content area displaying main content of the page; and a feedback entry icon in the main content area, floating over the main content of the page. The processor may further be configured to obtain a trigger instruction operated on the feedback entry icon; switch directly to a feedback window interface which corresponds to the feedback entry icon according to the trigger instruction; obtain feedback information with respect to the application or the main content inputted in the feedback window interface; submit the feedback information to a server in communication with the terminal device; and close the feedback window interface to return to the page.

According to another aspect of the present disclosure, a method for providing feedback of a subject application may comprise providing a browsing interface in a terminal device displaying a page associating with an subject application, wherein the page includes a main content area displaying main content of the page; and a feedback entry icon in the main content area, floating over the main content of the page. The method may further comprise obtaining, by the terminal device, a trigger instruction operated on the feedback entry icon; switching, by the terminal device, directly to a feedback window interface which corresponds to the feedback entry icon according to the trigger instruction; obtaining, by the terminal device, feedback information with respect to the application or the main content inputted in the feedback window interface; submitting, by the terminal device, the feedback information to a server in communication with the terminal device; and closing, by the terminal device, the feedback window interface to return to the page.

According to yet another aspect of the present disclosure, a processor-readable storage medium may comprise a set of instructions for providing feedback of a subject application, wherein the set of instructions, when executed by a processor of a terminal device, directs the processor to perform an action of providing a browsing interface in the terminal device displaying a page associating with the subject application, wherein the page includes a main content area displaying main content of the page; and a feedback entry icon in the main content area, floating over the main content of the page. Additionally, the set of instructions may be configured to direct the processor to perform actions of obtaining a trigger instruction operated on the feedback entry icon; switching directly to a feedback window interface which corresponds to the feedback entry icon according to the trigger instruction; obtaining feedback information with respect to the application or the main content inputted in the feedback window interface; submitting the feedback information to a server in communication with the terminal device; and closing the feedback window interface to return to the page.

### BRIEF DESCRIPTION OF THE DRAWINGS

FIG. 1A is a schematic diagram illustrating a feedback entry in a conventional browser page;

FIG. 1B is a schematic diagram illustrating a page that the browser enters into after the feedback entry in FIG. 1 is triggered.

FIG. 2 is a flowchart illustrating a method of providing feedback through a page of a software application installed in a terminal, according to example embodiments of the present disclosure;

FIG. 3 is a flowchart illustrating a method of providing feedback through a page of a software application installed in a terminal, according to example embodiments of the present disclosure;

FIG. 4 is a schematic diagram of a browser page where the method of providing feedback to an application is applied;

FIG. 5 is a schematic diagram of a feedback window interface corresponding to a pop-up feedback entry;

FIG. 6 is a structural diagram of a device of providing feedback through a computer application browsing interface according to one embodiment of the present disclosure.

FIG. 7 is a structural diagram of a device of providing feedback through a computer application browsing interface according to one embodiment of the present disclosure;

FIG. 8 is a structural diagram of a device of providing feedback through a computer application browsing interface according to one embodiment of the present disclosure;

FIG. 9 is a structural diagram of a device of providing feedback through a computer application browsing interface according to one embodiment of the present disclosure; and

FIG. 10 illustrates module diagram of a terminal that implements methods of providing feedback through a computer application browsing interface; and

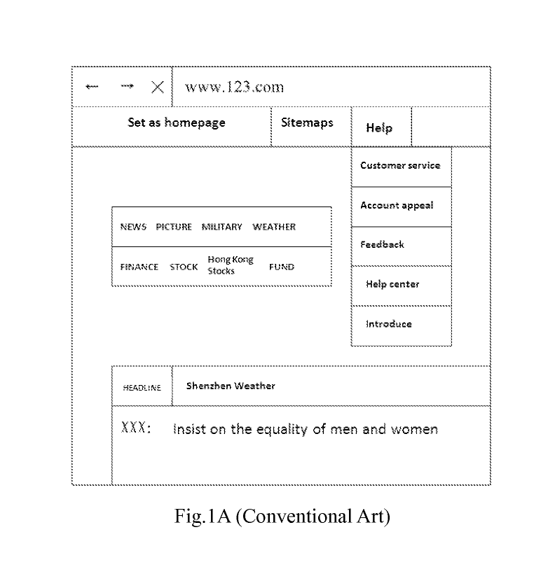

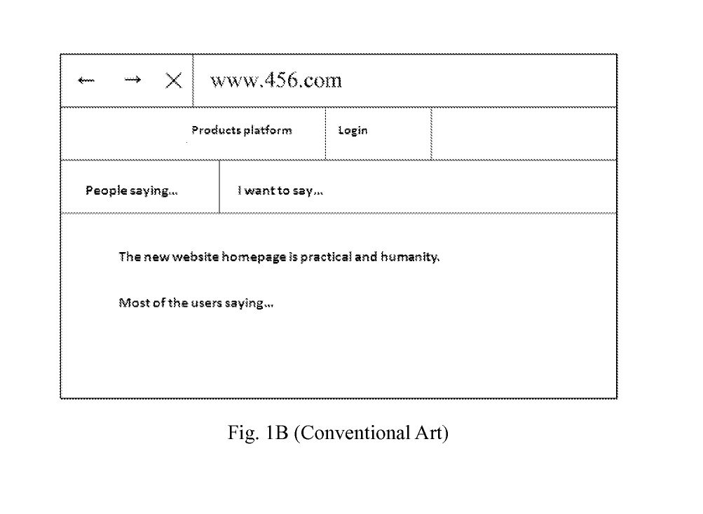

### DETAILED DESCRIPTION

Aspects, features, and advantages of this invention will become apparent from the following detailed description when taken in conjunction with the accompanying drawings. It should be noted that the embodiments described are merely used for explaining the invention, instead of limiting the invention.

Unless specified and clear description is mentioned in the present disclosure context, the quantity of the components and modules may be one or more, which is not limited. Although the steps in the invention has carried on the arrangement with the label, but the sequence of steps is not limited. The sequence of steps may be adjusted unless the sequence of steps is specified or the execution of the steps needs other steps as their foundation. It should be understood that the term “and/or” in the specification involves and covers one or a possible combination of the listed items.

FIG. 10 illustrates module diagram of a terminal that implements methods of providing feedback through a computer application browsing interface. The terminal 1000 is only an example that is suitable for the computer environment of the present disclosure. One of ordinary skill in the art would understand that the terminal 1000 is by no means limited to the range of application of the present disclosure. The present disclosure intends to include any suitable terminal that may implement the methods introduced therein.

The terminal 1000 is an example applying in the present disclosure shown in FIG. 10. Other systems with different subsystem configuration may also be used in the present disclosure, such as a desktop, a laptop, a personal digital assistant (PDA), a smart phone, a tablet and so on, which are not limited here.

As shown in FIG. 10, the terminal 1000 includes the processor 1010, the memory 1020 and the system bus 1022. Various system components, including the processor 1010 and the memory 1020, are connected to the system bus 1022. The processor 1010 is a hardware circuit that performs the computer program instruction by basic arithmetic and logic operations in the terminal. The memory 1020 is a physical device which is used for storing calculation programs or data (e.g., a program state information and/or sets of instructions executable by the processor) temporary or permanent. The system bus 1022 may be one of a peripheral bus, a local bus, a memory bus and a store controller. The processor 1010 and the memory 1020 may carry out data communication with each other through the system bus 1020. The memory 1020 includes read-only memory (ROM), flash memory (not shown in figures) and random access memory (RAM) which is a main memory with the operating system and application programs loaded.

The terminal 1000 also includes a display interface 1030 (such as a graphics processing unit), display equipment 1040 (such as a LCD), audio interface 1050 (such as a sound card) and audio equipment 1060 (such as a speaker). The display equipment 1040 and audio equipment 1060 media devices which pertain to the media devices for enjoying multimedia content.

The terminal 1000 also includes a storage equipment 1070. The storage equipment 1070 may be chosen from a variety of computer readable media. The computer readable medium may be any available medium compatible with the terminal 1000, such as removable medium and immovable medium. For example, the computer readable medium includes, but not limits to, flash memory (micro SD card), CD-ROM, digital general disc (DVD) or other CD storage, cassette, tape, disk storage or other magnetic storage devices, or any other media which may store the required information an may be accessed by the terminal 1000.

The terminal 1000 also includes the input device 1080 and the input interface 1090 such as IO controller). Users may input the instruction and information to the terminal 1000 by the input equipment 1080, such as a keyboard, a mouse, a touch panel equipment on the display unit 1040. The input equipment 1080 is usually connected to the system bus 1022 through the input interface 1090. It also may be connected by other interface or bus structure, such as universal serial bus (USB).

The terminal 1000 may logically connect with one or more network devices in the network environment. The network devices may be a personal computer, a server, a router, a smart phone, a tablet or other public network nodes. The terminal 1000 may be connected to network devices by a local area network (LAN) interface 1100 or a mobile communication unit 1110. The local area network (LAN) refers to an interconnection computer network in a limited regions, such as a house, a school, a computer laboratory, or an office building which uses network media. WiFi and twisted-pair cabling Ethernet are the most common technologies to a build local area network (LAN). WiFi is a technology which enables the terminals 1000 to wirelessly exchange data with each other or connect to the wireless network by radio waves. Mobile communication unit 1110 may answer and make calls through wireless telecommunication line when the terminal 1000 moves across a wide geographical area. In addition to answering and making calls, the mobile communications unit 1110 also support Internet access in 2G, 3G and 4G cellular communication system which provides mobile data service.

It should be noted that other terminal which includes more or less subsystems than the terminals 1000 also may be applicable to the present disclosure. For example, the terminal 1000 may include a Bluetooth unit for exchanging data in a short distance, a image sensor for taking pictures, and an accelerometer for measuring an acceleration.

As mentioned above, the suitable terminal 1000 may perform specified operations of the method of the providing feedback to an application. The specified operations are carried out by running software instructions in a computer readable medium via the processor 1010. These software instructions may be read into the memory 1020 via the storage device 1070 or another device through the local area network (LAN) interface. The software instructions stored in the memory 1020 direct the processor 1010 to perform the method of the providing feedback to an application. In addition, the present disclosure also may be achieved by hardware circuits or combinations of hardware circuit and software instructions. Therefore, the present disclosure is not limited to any specific combination of hardware circuit and software.

Merely for illustration, only one processor will be described in client devices that execute operations and/or method steps in the following example embodiments. However, it should be note that the client devices in the present disclosure may also include multiple processors, thus operations and/or method steps that are performed by one processor as described in the present disclosure may also be jointly or separately performed by the multiple processors. For example, if in the present disclosure a processor of a client device executes both step A and step B, it should be understood that step A and step B may also be performed by two different processors jointly or separately in the client device (e.g., the first processor executes step A and the second processor executes step B, or the first and second processors jointly execute steps A and B).

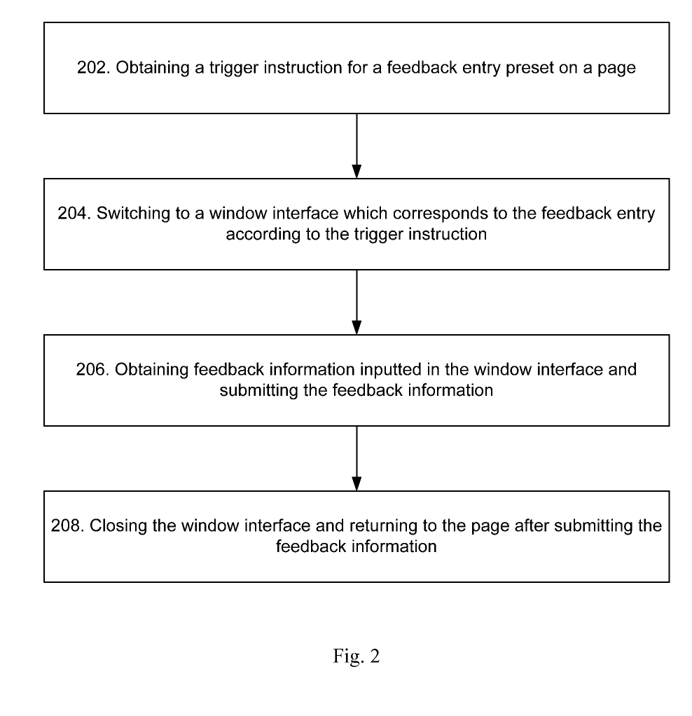

FIG. 2 is a flowchart illustrating a method of providing feedback through a browsing interface of a software application installed in a terminal, according to example embodiments of the present disclosure. For example, the application software may be a web browser, and the browsing interface may be a page of the browser. Accordingly, the method can be used in situations such as leaving feedback through the browser, sending a message within a website, making a short note or comments or placing a label in contents of a web page, where a user would prefer not to leave the current web page. The browser may be installed in the terminal 1100. The terminal 1100 may be a smartphone, a tablet personal computer, a laptop and a desk computer. As shown in FIG. 2, the method of providing feedback to an application may include the following steps:

Step 202, obtaining a trigger instruction of a preset feedback entry on a page.

The feedback entry (e.g., a feedback entry icon) may locate in a place of the browser page visible (e.g. visually obvious) to a user, such as in the lower right or the lower or upper right of the page, where a user reading the page may find it easily. This location may be pre-determined. The feedback entry may be a function and/or button of the page displayed on the browser. Alternatively, the feedback entry may be a function and/or button of the browser. The feedback entry may be a suggestion feedback entry, a site messages feedback entry, a notes and labels recording feedback entry or an opinion notation feedback entry, etc. The trigger instruction is produced when a user clicks a feedback entry control through an input equipment such as a keyboard, a touch screen, or a mouse.

Step 204, switching to a feedback window interface, which corresponds to the feedback entry, according to the trigger instruction.

The trigger instruction switches into the feedback window interface in the form of pop-up window, which corresponds to the feedback entry according to the trigger instruction. The size of the feedback window interface may be adjusted as the user requires. The size of the feedback window interface is smaller than the biggest size of the current page.

Step 206, obtaining feedback information inputted in the feedback window interface by the user, and submitting the feedback information to a server.

The server may be in communication with the terminal device to provide the application or a service through the application. For example, the application may be a browser, and the server may run a website which is displayed through the browser on the terminal device. The feedback information may be related to the application (e.g., a website displayed on the browsing interface) or the terminal device. The feedback information can be textual information edited and/or inputted by the user, images and/or voice messages uploaded by the user as attachments. The feedback information (e.g., the textual information, images, and/or the voice messages) is then submitted to a server in communication with the terminal, either through wired connection or through wireless connection. The application developers then can obtain the feedback information by downloading the feedback information (e.g., the textual information, the pictures, and/or the voice messages) from the server.

Step 208, closing the feedback window interface and returning to the page after submitting the feedback information.

In the above-mentioned method of providing feedback to an application, a user triggers the feedback entry on the page directly and the application (e.g., a browser) switches to the feedback window interface corresponding to the feedback entry instead of requiring the user to search the feedback entry through various menu functions and/or multiple pages, thereby saving the operation time. After the feedback information has been submitted, the application closes the feedback window interface directly, thus avoid the situation where the user is unable to return to the original page because of the searching through of various menu functions and/or multiple pages, thereby saving the operating time and improving operating efficiency. Further, because there are less steps required to provide feedback, the user makes less mistake, thus the method improves utilization rate of the network resource.

In one embodiment, Step 208 includes: automatically closing the feedback window interface and returning to the page after submitting the feedback information. When the application detects that the user submits the feedback information, the application automatically closes the feedback window interface. The method of automatically closing the feedback window interface simplifies the feedback operation and is time-saving.

In other embodiment, Step 208 includes: obtaining a closing instruction from the user to close the feedback window interface after submitting the feedback information, and then closing the feedback window interface and returning to the original page according to the closing instruction to close the feedback window interface.

This step allows the user to manually close the feedback window interface. Corresponding to this step, the application includes a closing control on the feedback window interface. The application will produce the closing instruction when the user triggers the closing control, and then close the feedback window interface and return to the original page accordingly. Allowing the user to close the feedback window interface manually may improve the flexibility of interaction and make the users choose conveniently.

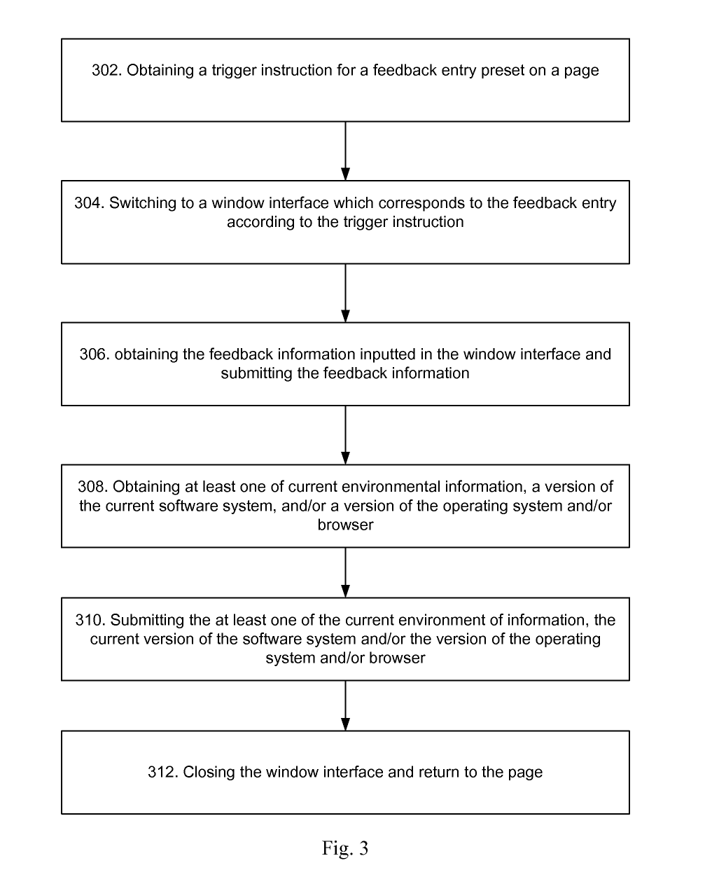

FIG. 3 is a flowchart illustrating a method of providing feedback through a page of a software application installed in a terminal, according to example embodiments of the present disclosure. For example, the application software may be a web browser, and the browsing interface may be a page of the browser. Accordingly, the method may be used in situations such as leaving feedback through the browser, sending a message within a website, making a short note or comments or placing a label in contents of a web page, where a user would prefer not to leave the current web page. The browser may be installed in the terminal 1100. The terminal 1100 may be a smartphone, a tablet personal computer, a laptop and a desk computer. The method includes the following steps.

Step 302, obtaining a trigger instruction of a preset feedback entry on the page.

The feedback entry may locate in an area where main content of the page is displayed. The location and visual appearance of the feedback entry may be visually obvious to a user. For example, the location of the feedback entry may be, but not limited to, in the lower right or the lower or upper right of the page or a main content section of the page. Further, the feedback entry may be floating over content of the page, so that the position of the feedback entry does not change when a user scrolls down the page. The feedback entry may be a suggestion feedback entry, a site messages feedback entry, a note and label recording feedback entry or an opinion notation feedback entry, etc. The trigger instruction is produced by clicking the feedback entry controls through an input equipment such as a keyboard, a touch screen or a mouse.

Step 304, switching to a feedback window interface which corresponds to the feedback entry according to the trigger instruction.

Concretely, the trigger instruction switch into the feedback window interface in the form of pop-up window, which correspond to the feedback entry according to the trigger instruction.

Step 306, obtaining the feedback information inputted in the feedback window interface and submitting the feedback information.

The feedback information includes at least one of edit words, image added in the form of attachment and the voice information.

Step 308, obtaining at least one of current environmental information, a version of the current software system, and/or a version of the operating system and/or browser.

The current environmental information may include testing environment information, development environment information, operational and production environment information, etc. The software version number of current system may be the software version number of the current application software. The operating system may be the Android operating system, Windows system, Linux system, the IOS system, etc. or any other operating system one of the ordinary skill in the art would perceive at the time of invention and in the future. The version information of browser may be the version of the current browser, such as 1E8 or 1E7, etc. The current environment of information, software version number of a current system, operating system information, and/or the version information of browser is recorded by the way of cookies, and at least one of them is obtained in the cookies.

Step 310, submitting the at least one of the current environment of information, the current version of the software system and/or the version of the operating system and/or browser. The current environment of information, the current version of the software system and/or the version of the operating system and/or browser may be submitted together with the feedback information.

Step 312, after the submission, closing the feedback window interface and return to the page.

In other embodiments, the steps of obtaining at least one of current environment of information, software version number of a current system, and/or operating systems, and/or version information of browser and obtaining the feedback information may be performed and submitted at the same time.

The above-mentioned method of providing feedback to an application, triggers the feedback entry on the page directly and switches to the feedback window interface corresponding to the feedback entry, instead of searching the feedback entry in various menu functions on the page, thereby saving the operation time. After the feedback information after submitting the feedback information, and closing the feedback window interface directly, instead of failing to returns to the original page due to page skipping, thereby saving the operating time and improving operating efficiency, further improving utilization rate of the network resource due to no faulty operation happened. It helps the developers improving and perfecting the function of page by obtaining and submitting at least one of the current environment of information, the current version of the software system and the version of the operating system and browser.

In an embodiment, the above-mentioned method of providing feedback to an application also includes: obtaining a drag instruction of the scroll bar of the page; moving the scroll bar according to the drag instruction and the feedback entry moving along with the scroll bar.

The method includes monitoring the scroll bar of the page. When the position of the scroll bar is changed, relative coordinates of the feedback entry and the scroll bar will be modified, so that the feedback entry moves along with the scroll bar. In another word, for the user, the feedback entry “floats over” main content of the page and is kept in a same position on the screen of the terminal 1100 whatever the scroll bar is pulled up and down, so that the user may easily access the feedback entry and provide his/her feedback.

In an embodiment, the feedback information includes editable textual information (e.g., editable textual information). Before the step of submitting the feedback information, it also includes setting personalized configuration for the textual information. The personalized configuration may include the functions of HTML (Hyper Text Markup Language) page such as the size of the word, the color of the word, the style of calligraphy, overstriking of the word, underline, etc. In such a way, different users' demands are met.

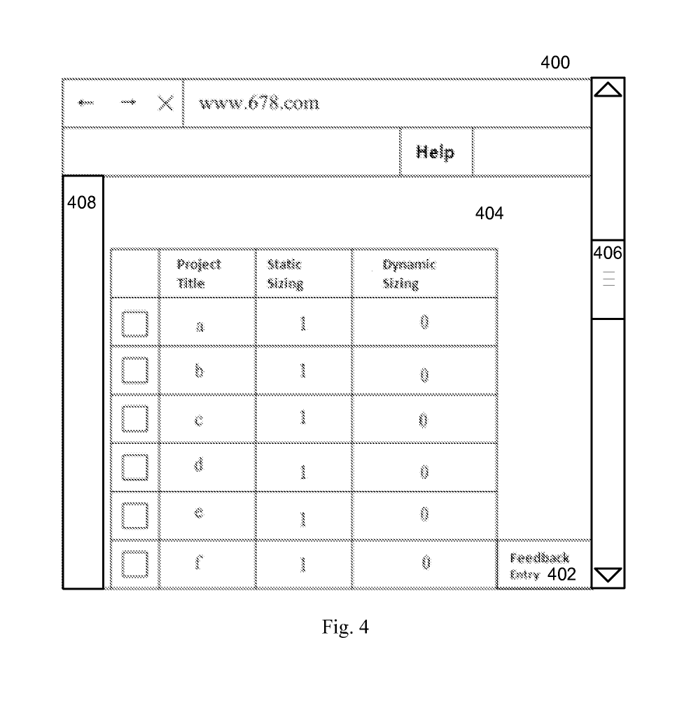

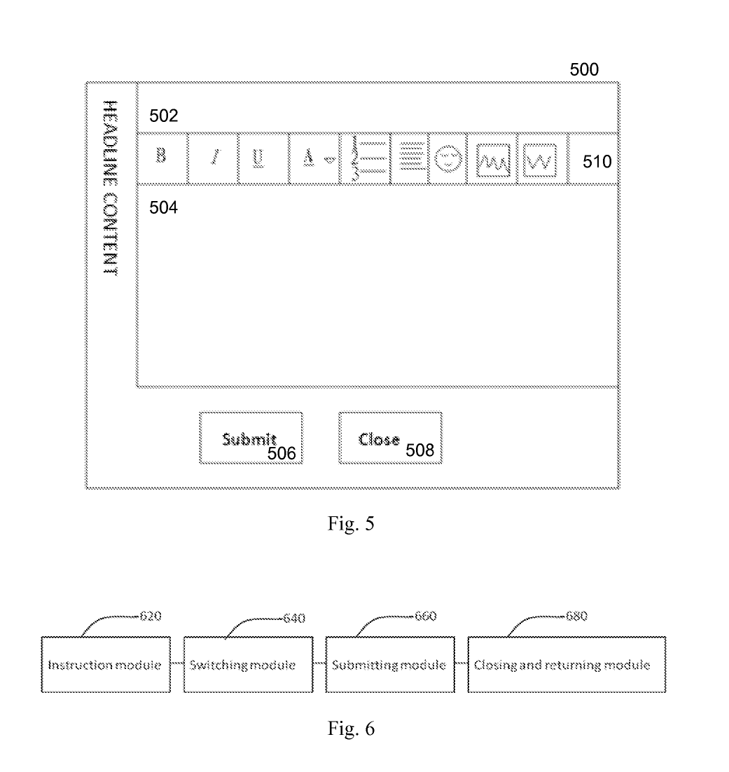

FIG. 4 is a schematic diagram of a browser page where the method of providing feedback to an application is applied. FIG. 5 is a schematic diagram of a feedback window interface corresponding to a pop-up feedback entry. The page 400 on a browser in FIG. 4 includes a main content area 404, a page map area 408, and a scroll bar 406. The main content area displays main content of the page, wherein the main content is what the page 400 is mainly designed to deliver to a user. The page map area 408 may include mapping information of the application (e.g., website), operation guiding information of the application, and/or advertisements and or any other information not directly related to the main content. The scroll bar 406 appears on one side of the page 400 when the main content 404 of the page 400 is too long, so that a user can drag the scroll bar to scroll down the content to read. The page 400 also includes a control of “feedback entry” 402 at the bottom right of the page. The control of “feedback entry” 402 floats over the main content area 404 so that a scrolling-down operation on the scroll bar 406 does not move the control of “feedback entry” 402 on page 400. Clicking the control of “feedback entry” 402 results in the trigger instruction, so that the feedback window interface 500 shown in FIG. 5 pops up. The feedback window interface 500 may be a window independent from the page 400, or may be a floating window over the page 400. The feedback window interface 500 includes a title frame 502, the content frame 504, the control of submitting 506, and the control of closing 508. A title name may be inputted in the title frame 502. Words or images or voice message may be entered or added in the content frame 504. And a set of controls 510 are set on the content frame 504, by which the personalized configuration for the words may be set.

FIG. 6 is a structural diagram of a device of providing feedback through a computer application browsing interface according to one embodiment of the present disclosure. The device may be the terminal 1100. The terminal 1100 may be a smartphone, a tablet personal computer, a laptop and a desk computer. The device of providing feedback through a computer application browsing interface includes: an instruction module 620, a switching module 640, a submitting module 660, a closing and returning module 680.

The instruction module 620 is configured to obtain a trigger instruction of preset feedback entry on the page.

The feedback entry may be set up in a visible place in advance, such as in the lower right or the lower or upper right of the page, but not limited to this. The feedback entry may be a suggestion feedback entry, a site messages feedback entry, a notes and labels recording feedback entry or an opinion notation feedback entry, etc. The trigger instruction is produced by clicking the feedback entry controls through an input equipment such as a keyboard, a touch screen or a mouse.

The switching module 640 is configured to switch into the feedback window interface which corresponds to the feedback entry according to the trigger instruction.

The trigger instruction switches the page 400 into the feedback window interface 500 in the form of pop-up window, which correspond to the feedback entry according to the trigger instruction. The size of the feedback window interface 500 may be adjusted as required. For example, buy placing a cursor on an edge of the pop-up feedback window interface 500 and left click the mouse, a user may be able to adjust the size of the feedback window interface 500. The size of the feedback window interface 500 is smaller than the biggest size of the current page.

The submitting module 660 is configured to obtain feedback information inputted in feedback window interface, and submit the feedback information. The feedback information includes at least one of the editable textual information, the image information added in the form of attachment and the voice information. The pictures and the voice messages are uploaded to the specified server in the form of enclosure. The developers obtain the feedback information by download the pictures and the voice messages from the specified server.

The closing and returning module 680 is configured to close the feedback window interface and return to the page after submitting the feedback information.

For example, the closing and returning module 680 may be preset to automatically close the feedback window interface after submitting the feedback information. Accordingly, the closing and returning module 680 automatically closes the feedback window interface after detecting that the feedback information has been submitted.

Alternatively, the closing and returning module 680 may be configured to obtain an instruction to close the feedback window interface and return to the page after submitting the feedback information. Specifically, there is a closing control on the feedback window interface. It will produce a closing instruction when being manually triggered by a user. The closing instruction closes the feedback window interface and the application software then returns to the page. Closing the feedback window interface by manual control may improve the flexibility of interaction and make the users choose conveniently.

The above-mentioned device providing feedback through an application browsing interface, triggers the feedback entry on the page directly and switches to the feedback window interface corresponding to the feedback entry, instead of searching the feedback entry in various menu functions on the page, thereby saving the operation time. After submitting the feedback information, and closing the feedback window interface directly, instead of failing to returns to the original page due to page skipping, thereby saving the operating time and improving operating efficiency, further improving utilization rate of the network resource due to no faulty operation happened.

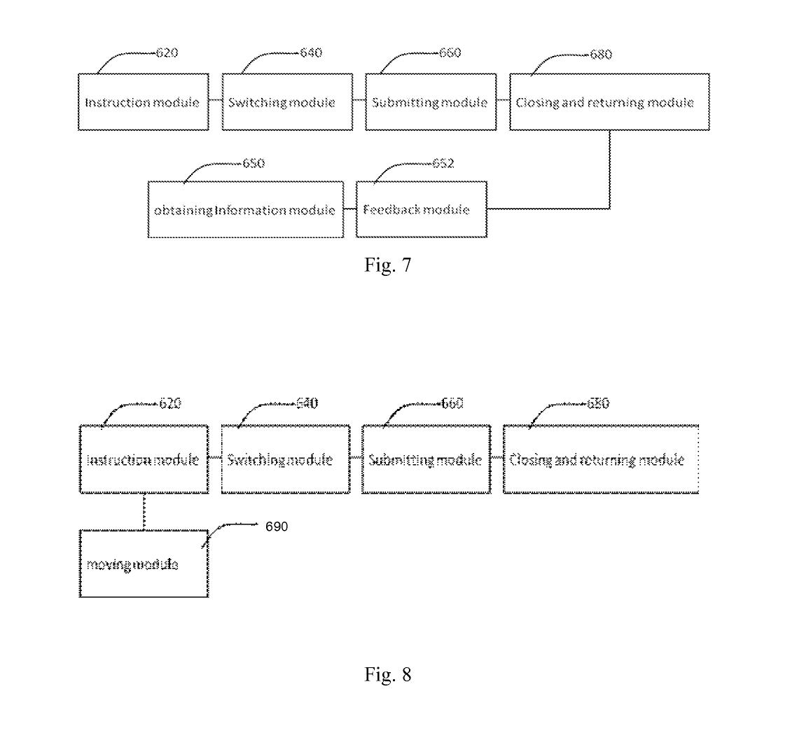

FIG. 7 is a structural diagram of a device of providing feedback through a computer application browsing interface according to one embodiment of the present disclosure. In addition to the instruction module 620, the switching module 640, the submitting module 660, the closing and returning module 680 shown in FIG. 6, the device in FIG. 7 also includes an obtaining information module 650 and a feedback module 652.

The obtaining information module 650 is configured to obtain at least one of the current environmental information, the current version of the software system and the version of the operating system and browser.

The current environmental information includes the testing environment information, the development environment information, operational and production environment information, etc. The software version number of current system refers to the software version number of the current application software. The operating system refers to the Android operating system, Windows system, Linux system, and the IOS system, etc. that one of ordinary skill in the art would have perceived at the time of the application and in the future. The version information of browser refers to the version of the current browser, such as 1E8 or 1E7, etc.

The feedback module 652 is configured to submit at least one of the current environment of information, the current version of the software system and the version of the operating system and browser.

FIG. 8 is a structural diagram of a device of providing feedback through a computer application browsing interface according to one embodiment of the present disclosure. In addition to the instruction module 620, the switching module 640, the submitting module 660, the closing and returning module 680 in FIG. 6, the device in FIG. 8 also includes a moving module 690.

In addition to the function introduced in FIG. 6, the instruction module 620 is also configured to obtain the drag instruction of scroll bar of the page.

The moving module 620 is configured to move the scrollbar according to the drag instruction and the feedback entry moves following the scrollbar. Specifically, the moving module 620 monitors the scroll bar of the page. When the position of the scroll bar is changed, relative coordinates of the feedback entry and the scroll bar will be modified, so that the feedback entry moves along with the scroll bar and/or the feedback entry floats over content of the page and keeps in the same position on a screen of the device.

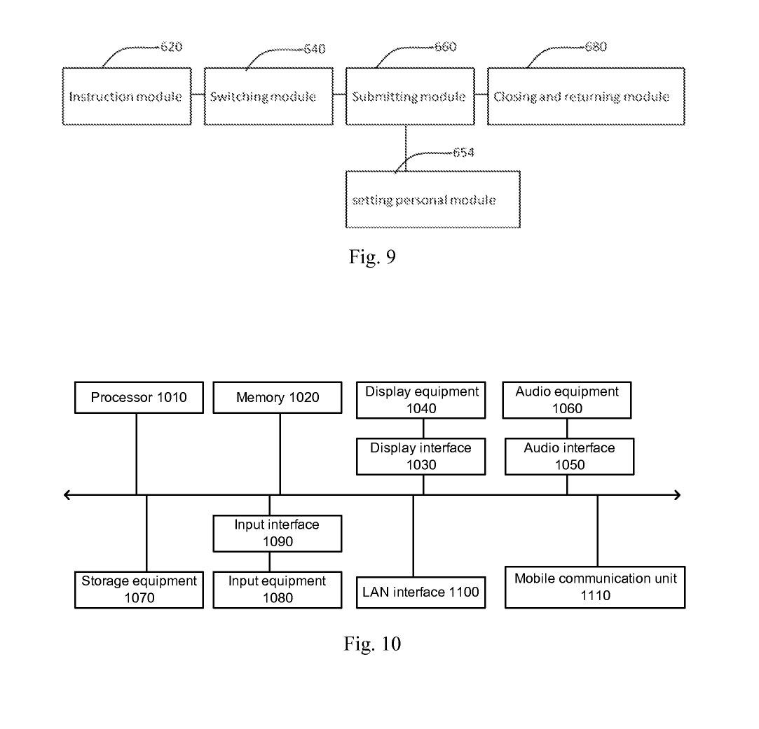

FIG. 9 is a structural diagram of a device of providing feedback through a computer application browsing interface according to one embodiment of the present disclosure. The above-mentioned device of providing feedback through a computer application browsing interface also includes a setting personal configuration module 654 in addition to the instruction module 620, the switching module 640, the submitting module 660, and the closing and returning module 680 shown in FIG. 6.

When the feedback information includes editable textual information, the setting personal configuration module 654 is configured to set personalized configuration for the textual information before submitting the feedback information. The personalized configuration may include the functions of HTML (Hyper Text Markup Language) page such as the size of the word, the color of the word, the style of calligraphy, overstriking of the word, underline, etc. In such a way, different users' demands are met.

In other embodiment, the above-mentioned device of providing feedback through a computer application browsing interface also includes the instruction module 620, the switching module 640, the obtaining information module 650, the feedback module 652, the setting personal configuration module 654, the submitting module 660, the closing and returning module 680, and the moving module 690.

The embodiments mentioned above are partial embodiments of the present disclosure, which have specific and detained description, should not be understood to a limitation of the scope of the present disclosure however. It should be noted that, for persons ordinarily skilled in the art, any replacements or modifications made according to the contemplation of the present disclosure are within the protection scope of the present disclosure. Thus the protection scope of the present disclosure should be defined by the enclosed claims.

What is claimed is:

1. A terminal device, comprising:
a processor-readable storage medium comprising a set of instructions for providing feedback regarding a subject application; and
a processor in communication with the storage medium, configured to execute the set of instructions to:
provide a browsing interface in a terminal device displaying a page associated with the subject application, wherein the page includes a main content area displaying main content of the page; and
a feedback entry icon in the main content area, floating over the main content of the page;
obtain a trigger instruction operated on the feedback entry icon;
switch directly to a feedback window interface which corresponds to the feedback entry icon according to the trigger instruction;
obtain feedback information with respect to the application or the main content inputted in the feedback window interface;
submit the feedback information to a server in communication with the terminal device; and
close the feedback window interface to return to the page.

2. The terminal device of claim 1, wherein
the interface is a browser;
the subject application is an internet website;
the page is a web page of the internet website; and
the feedback window interface is a floating window over the browsing interface.

3. The terminal device of claim 1, wherein the processor is further configured to:
obtain at least one of current environmental information, software version number of the subject application, operating system information of the terminal device, and version information of the browsing interface;
submit the at least one of the current environmental information, the software version number of the subject application, the operating system information of the terminal device, and the version information of the browsing interface together with the feedback information.

4. The terminal device of claim 1, wherein the processor is further configured to:
obtaining a drag instruction to a scroll bar on the interface to scroll the main content on the page;
moving the scroll bar and the main content displayed on the page according to the drag instruction, and
moving the feedback entry icon along with the scroll bar or keeping a position of the feedback entry icon with respect to the browsing interface.

5. The terminal device of claim 1, wherein the feedback information comprises at least one of editable textual information, image information and voice information.

6. The terminal device of claim 5, wherein the feedback window interface is configured to allow a user to personalize a configuration for the textual information.

7. The terminal device of claim 1, wherein closing the feedback window interface comprises:
automatically closing the feedback window interface and then returning to the page after submitting the feedback information; or
obtaining a close instruction from a user for closing the feedback window interface after submitting the feedback information, closing the feedback window interface, and returning to the page according to the close instruction.

8. A method for providing feedback concerning a subject application, comprising:
providing a browsing interface in a terminal device displaying a page associated with an subject application, wherein the page includes a main content area displaying main content of the page; and a feedback entry icon in the main content area, floating over the main content of the page;
obtaining, by the terminal device, a trigger instruction operated on the feedback entry icon;
switching, by the terminal device, directly to a feedback window interface which corresponds to the feedback entry icon according to the trigger instruction;
obtaining, by the terminal device, feedback information with respect to the application or the main content inputted in the feedback window interface;
submitting, by the terminal device, the feedback information to a server in communication with the terminal device; and
closing, by the terminal device, the feedback window interface to return to the page.

9. The method of claim 8, wherein
the interface is a browser;
the subject application is an internet website;
the page is a web page of the internet website; and
the feedback window interface is a floating window over the browsing interface.

10. The method of claim 8, further comprising:
obtaining at least one of current environmental information, software version number of the subject application, operating system information of the terminal device, and version information of the browsing interface;
submitting the at least one of the current environmental information, the software version number of the subject application, the operating system information of the terminal device, and the version information of the browsing interface together with the feedback information.

11. The method of claim 8, further comprising:
obtaining a drag instruction to a scroll bar on the interface to scroll the main content on the page;
moving the scroll bar and the main content displayed on the page according to the drag instruction, and
moving the feedback entry icon along with the scroll bar or keeping a position of the feedback entry icon with respect to the browsing interface.

12. The method of claim 8, wherein the feedback information comprises at least one of editable textual information, image information and voice information.

13. The method of claim 12, wherein the feedback window interface is configured to allow a user to personalize a configuration for the textual information.

14. The method of claim 8, wherein closing the feedback window interface comprises:
automatically closing the feedback window interface and then returning to the page after submitting the feedback information; or
obtaining a close instruction from a user for closing the feedback window interface after submitting the feedback information, closing the feedback window interface, and returning to the page according to the close instruction.

15. A processor-readable storage medium, comprising a set of instructions for providing feedback regarding a subject application, wherein the set of instructions, when executed by a processor of a terminal device, directs the processor to perform actions of:
providing a browsing interface in the terminal device displaying a page associating with the subject application, wherein the page includes:
a main content area displaying main content of the page; and
a feedback entry icon in the main content area, floating over the main content of the page;
obtaining a trigger instruction operated on the feedback entry icon;
switching directly to a feedback window interface which corresponds to the feedback entry icon according to the trigger instruction;
obtaining feedback information with respect to the application or the main content inputted in the feedback window interface;
submitting the feedback information to a server in communication with the terminal device; and
closing the feedback window interface to return to the page.

16. The storage medium of claim 15, wherein
the interface is a browser;
the subject application is an internet website;
the page is a web page of the internet website; and
the feedback window interface is a floating window over the browsing interface.

17. The storage medium of claim 15, wherein the set of instructions is further configured to direct the processor to perform actions of:
obtaining at least one of current environmental information, software version number of the subject application, operating system information of the terminal device, and version information of the browsing interface;
submitting the at least one of the current environmental information, the software version number of the subject application, the operating system information of the terminal device, and the version information of the browsing interface together with the feedback information.

18. The storage medium of claim 15, wherein the set of instructions is further configured to direct the processor to perform actions of:
obtaining a drag instruction to a scroll bar on the interface to scroll the main content on the page;
moving the scroll bar and the main content displayed on the page according to the drag instruction, and
moving the feedback entry icon along with the scroll bar or keeping a position of the feedback entry icon with respect to the browsing interface.

19. The storage medium of claim 15, wherein the feedback information comprises at least one of editable textual information, image information and voice information; and
the feedback window interface is configured to allow a user to personalize a configuration for the textual information.

20. The storage medium of claim 15, wherein closing the feedback window interface comprises:
automatically closing the feedback window interface and then returning to the page after submitting the feedback information; or
obtaining a close instruction from a user for closing the feedback window interface after submitting the feedback information, closing the feedback window interface, and returning to the page according to the close instruction.
